(19) United States
(12) Patent Application Publication
(10) Pub. No.: US 2026/0304304 A1
(43) Pub. Date: Oct. 1, 2026

(54) METHOD FOR SELECTING A NON-3GPP ACCESS NETWORK IN A WIRELESS COMMUNICATION NETWORK

(71) Applicant: LENOVO (SINGAPORE) PTE. LTD., Singapore (SG)

(72) Inventors: Apostolis Salkintzis, Glika Nera (GR); Genadi Velev, Darmstadt (DE); Dimitrios Karampatsis, Ruislip (GB)

(73) Assignee: Lenovo (Singapore) Pte. Limited, Singapore (SG)

(21) Appl. No.: 19/100,864

(22) PCT Filed: Sep. 23, 2022
(86) PCT No.: PCT/EP2022/076592

§ 371 Date: Feb. 3, 2025

(30) Foreign Application Priority Data
Aug. 5, 2022 (GR) 20220100653

(51) Int. Cl. H04W 48/18

(52) U.S. Cl. CPC H04W 48/18

(57) ABSTRACT

There is provided a method comprising creating a first list of available public land mobile networks, PLMNs, connectable via available non-3GPP access networks using a first connectivity type, selecting from the first list of available PLMNs a first PLMN, creating a second list of available non-3GPP access networks, the second list containing all available non-3GPP access networks that support connectivity using the first connectivity type to the first PLMN and one or more Network Slice Non-3GPP Access Groups, NSNAGs, supported by each of the available non-3GPP access networks, determining network slices associated with the NSNAGs in the second list, selecting a first non-3GPP access network from the second list of available non-3GPP access networks, wherein the first non-3GPP access network supports the first type of connectivity to a requested network slice in the first PLMN, wherein the requested network slice is a network slice associated with one or more NSNAGs in the second list, and beginning a registration procedure with the first PLMN, the registration procedure requesting support of the requested network slice in the first PLMN.

### FIELD

The subject matter disclosed herein relates generally to wireless communication networks.

### BACKGROUND

A non-3GPP access network (e.g., a wireless local area network, WLAN) may support interfaces with mobile networks (e.g., public land mobile networks, PLMNs) in order to enable wireless devices (e.g., user equipment, UE) to connect to these mobile networks and utilize their services. When a wireless device wishes to connect to a mobile network via a non-3GPP access network, the wireless device requires a method for selecting a non-3GPP access network to use.

### SUMMARY

A problem with existing methods for selecting a non-3GPP access network is that network slicing information is not considered.

Disclosed herein are procedures for selecting a non-3GPP access network. Said procedures may be implemented by a wireless device such as a UE.

In an aspect, there is provided a method comprising creating a first list of available public land mobile networks, PLMNs, connectable via available non-3GPP access networks using a first connectivity type, selecting from the first list of available PLMNs a first PLMN, creating a second list of available non-3GPP access networks, the second list containing all available non-3GPP access networks that support connectivity using the first connectivity type to the first PLMN and one or more Network Slice Non-3GPP Access Groups, NSNAGs, supported by each of the available non-3GPP access networks, determining network slices associated with the NSNAGs in the second list, selecting a first non-3GPP access network from the second list of available non-3GPP access networks, wherein the first non-3GPP access network supports the first type of connectivity to a requested network slice in the first PLMN, wherein the requested network slice is a network slice associated with one or more NSNAGs in the second list, and beginning a registration procedure with the first PLMN, the registration procedure requesting support of the requested network slice in the first PLMN.

The creation of the first list may comprise discovering all available non-3GPP access networks, for each available non-3GPP access network identifying one or more PLMNs to which the first connectivity type is supported, and including all the PLMNs to which the first connectivity type is supported in the first list.

The method may further comprise for each available non-3GPP access network, identifying one or more NSNAGs in each PLMN.

The determination of the network slices associated with each NSNAG may be performed using NSNAG information received either: within an Access Network Discovery and Selection Policy, ANDSP, of the first PLMN or within a Registration Accept message received from the first PLMN.

The ANDSP of the first PLMN may be provided with an N1 signaling procedure.

The ANDSP of the first PLMN may be provided using a user equipment, UE, policy management procedure.

The non-3GPP access networks may comprise Wireless Access Networks, WLANs.

The first connectivity type may be 5G connectivity.

The determination of the network slices may comprise determination of Network Slice Selection Assistance Information, S-NSSAI.

The NSNAG information may contain one or more NSNAG identifiers and a list of associated S-NSSAIs for each NSNAG identifier.

The method may be performed by a UE.

In a further aspect, there is provided an apparatus configured to perform the method of the aspect described above. The apparatus may be a UE.

In yet a further aspect, there is provided a wireless communication device comprising a receiver arranged to receive an Access Network Discovery and Selection Policy, ANDSP, from a first PLMN, the ANDSP comprising network slice group information that contains a list of network slice groups applicable to non-3GPP access and one or more S-NSSAIs associated with each network slice group, wherein the wireless communication device is configured to apply the network slice group information for selecting a non-3GPP access network that supports a first type of connectivity to a requested network slice in the first PLMN.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for selecting a non-3GPP access network will now be described, by way of example only, with reference to the accompanying drawings, in which:

FIG. 1A illustrates a wireless communication system;

FIG. 1B illustrates a UE, non-3GPP access networks and mobile networks of the wireless communication system;

FIG. 2 illustrates a user equipment apparatus;

FIG. 3 illustrates a network node;

FIG. 4 illustrates interactions between a UE, non-3GPP access networks and mobile networks of the wireless communication system; and

FIG. 5 illustrates a flowchart of a method performed within the wireless communication system.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram. The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of preceding Figures. Like numbers refer to like elements in all Figures.

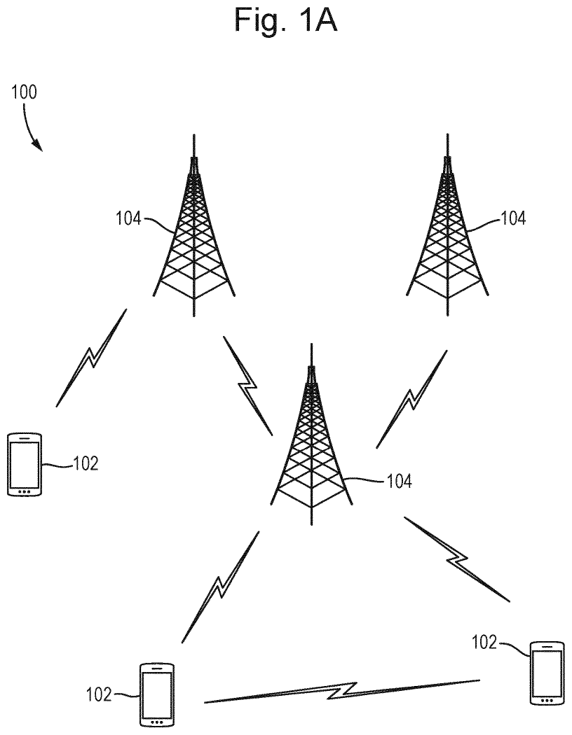

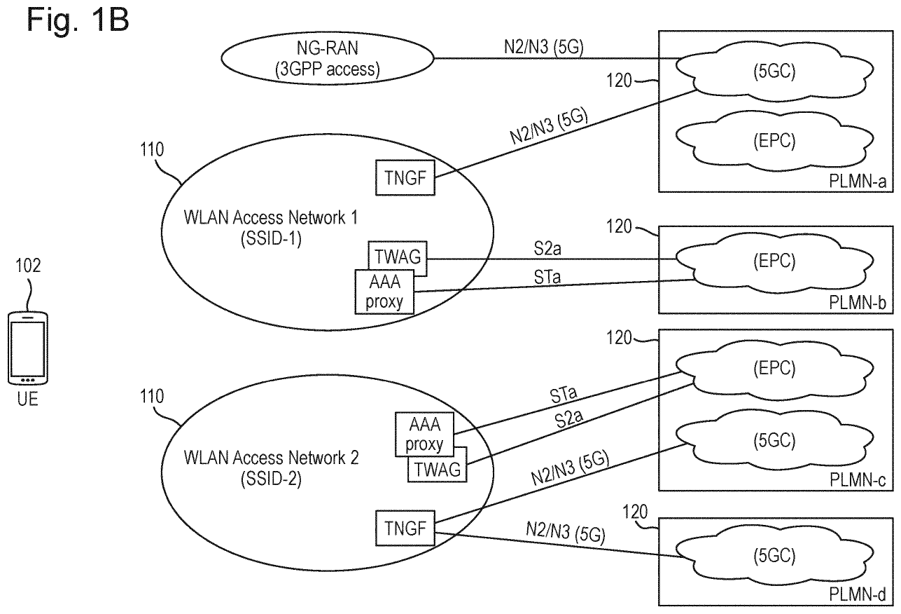

FIG. 1 depicts an embodiment of a wireless communication system 100 for selecting a non-3GPP access network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

A non-3GPP access network (e.g., a WLAN) may support interfaces with mobile networks (e.g., PLMNs) in order to enable wireless devices (e.g., UEs) to connect to these mobile networks and utilize their services. For example, a WLAN access network may support the N2 interface and the N3 interface (specified in TS 23.501) with a PLMN for connecting wireless devices to the 5G core (5GC) network in this PLMN via WLAN access. In addition, a WLAN access network may support the STa/SWa interfaces and the S2a interface (specified in TS 23.401) with a PLMN for connecting wireless devices to the Evolved Packet Core (EPC) network in this PLMN via WLAN access.

FIG. 1B illustrates an example with such WLAN access networks 110. More specifically, FIG. 1B illustrates “Trusted” WLANs 110 connected to EPCs and 5GCs in several PLMNs 120. Note that “Trusted” WLANs are connected to EPC using the STa interface and the S2a interface (as shown in FIG. 1B), while “Untrusted” WLANs are connected to EPC using the SWa interface and the S2a interface.

All network functions shown in FIG. 1B are already specified in 3GPP TS 23.501, TS 23.402 and TR 23.716. Specifically:
The Trusted Non-3GPP Gateway Function (TNGF) is specified in TR 23.716. It is the functional element used to interface a trusted non-3GPP access network 110 with the 5G core (5GC) network in one or more PLMNs 120. The TNGF provides both the control-plane interface (N2) and the user-plane interface (N3).
The Trusted WLAN Access Gateway (TWAG) and the AAA Proxy are specified in TS 23.402. They are used to interface a trusted WLAN access network 110 with the Evolved Packet Core (EPC) in one or more PLMNs 120. The TWAG provides the user-plane interface (S2a) and the AAA Proxy provides the control-plane interface (STa/SWa) for authentication, authorization and accounting.
The functional elements inside the 5GC (e.g. AMF, SMF, UPF, etc.) are specified in TS 23.501 and the functional elements inside the EPC (e.g. MME, PGW, etc.) are specified in TS 23.401 and TS 23.402.

When a wireless device 102 wants to register to (also referred to as “connect to”) a PLMN 120 via a non-3GPP access network 110, the wireless device 102 requires a method for selecting (a) the PLMN 120 to connect to via non-3GPP access 110, (b) the core network (EPC or 5GC) in this PLMN 120 to connect to and (c) the non-3GPP access network 110 to connect to that provides connectivity to the selected core network in the selected PLMN 120. Such a method is specified in TS 23.501 for Rel-16 and Rel-17 (see clause 6.3.12).

This method, however, does not consider network slicing information for selecting the non-3GPP access network 110 to connect to because it was assumed in 3GPP specifications that a non-3GPP access network 110 that supports 5G connectivity to a PLMN 120 could be used to connect to any network slice in this PLMN 120.

However, this assumption is not valid anymore because, in 3GPP Rel-17, it was specified that a non-3GPP access network 110 may be able to support connectivity only to specific network slices in a PLMN 120 (i.e., not to all network slices in the PLMN 120). Hence, if the UE 102 selects a non-3GPP access network 110 based on methods in TS 23.501 for Rel-16 and Rel-17 (see clause 6.3.12), the UE 102 may select a non-3GPP access network 110 that cannot support connectivity to the network slice requested by the UE 102. For this reason, an updated selection method is needed that also considers the network slices to which 5G connectivity can be supported by a non-3GPP access network 110.

This issue of how the UE 102 can select a non-3GPP access network 110 to connect to a specific network slice in a 5G PLMN 120 is considered in the 5WWC_ph2 study item in Rel-18. In this context, the solution 12 in TR 23.700-17 specifies that a trusted non-3GPP access network 110 (identified by an SSID) may advertise, either: a) a list of S-NSSAI(s) in a PLMN 120, which are connectable via this access network 110, or b) a list of Network Slice Access Stratum Groups (NSASGs) in a PLMN 120, which are connectable via this access network 110.

The present disclosure describes a method in which:
i) the non-3GPP access network 110 advertises a list of network slice groups (called Network Slice Non-3GPP Access Groups, NSNAGs), which are different types of groups from the NSASGs described in b) above; and
ii) a method is defined with which the UE 102 can determine the S-NSSAIs associated with a NSNAG and applies the determined S-NSSAIs to select a non-3GPP access network.
   Based on the above two points i) and ii), described herein is an updated selection method usable by a UE 102 that considers the network slices to which 5G connectivity can be supported by the non-3GPP access networks 110 detectable by the UE 102.

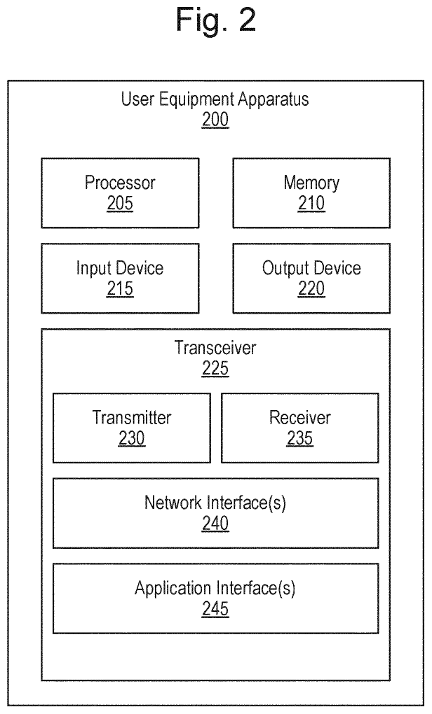

FIG. 2 depicts a user equipment apparatus 200 (which may also be referred to as a wireless communication device) that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 is in accordance with and/or the same as the remote unit/UE 102 of FIGS. 1A and 1B. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

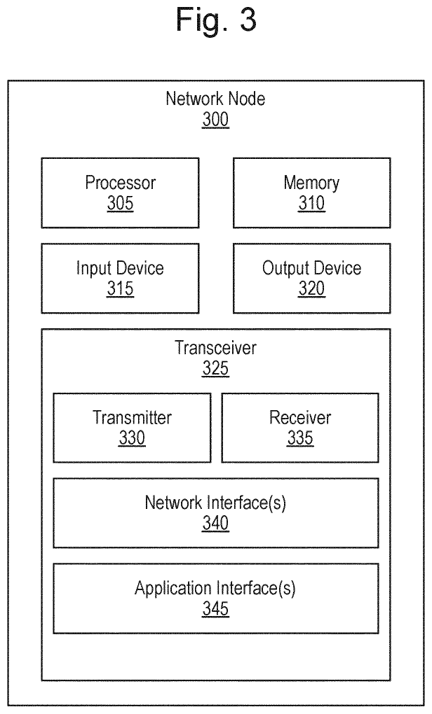

FIG. 3 depicts further details of the network node 300 that may be used for implementing the methods described herein. The network node 300 may be one implementation of an entity in the wireless communications network, e.g. in one or more of the wireless communications networks described herein, e.g. the wireless communication network 100. The network node 300 may be the same as or in accordance with the network unit 104 of FIG. 1A. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with a UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

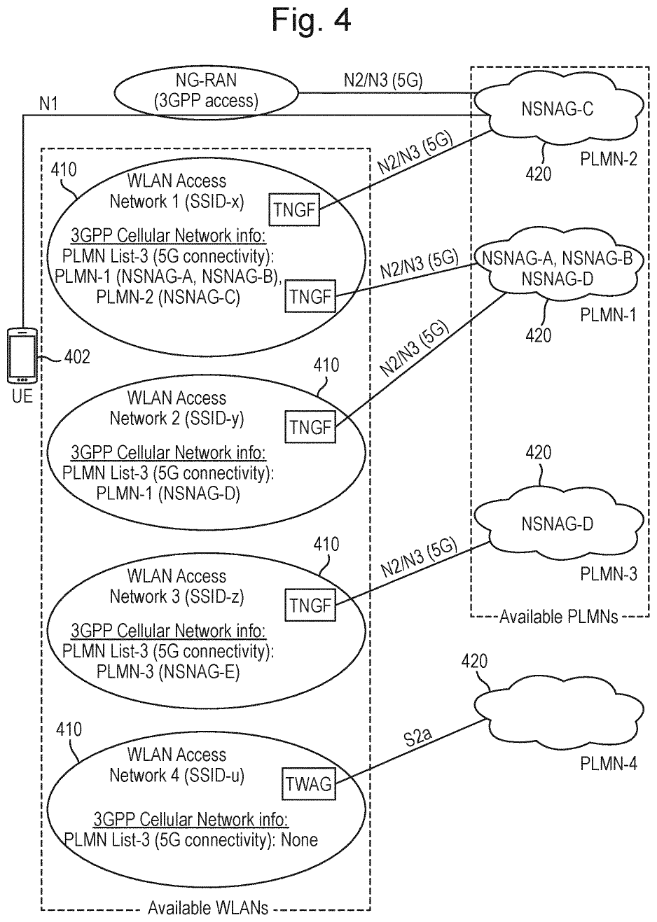

FIG. 4 illustrates an embodiment for Trusted Non-3GPP Access Selection based on Slicing Information.

The method specified below uses the example deployment scenario illustrated in the embodiment of FIG. 4. In the embodiment of FIG. 4, WLAN access networks 410 are considered as a typical embodiment of “trusted” non-3GPP access networks. A non-3GPP access network 410 is considered “trusted” from a PLMN 420 point of view, when this access network supports a TNGF, which connects to the PLMN 420 using the regular N2/N3 interfaces. Such a non-3GPP access network 410 is said to support “5G connectivity” to the PLMN 420.

In a zeroth step (“step 0”), the UE 402 decides to register to a particular network slice in a 5G PLMN 420 over non-3GPP access. This may be decided e.g., when the UE 402 is registered only over 3GPP access and attempts to send data traffic which, according to the URSP rules in the UE 402, should be sent over non-3GPP access and via a PDU Session using the particular network slice. Before the UE 402 initiates the registration procedure, the UE 402 needs to select (2) a 5G PLMN 420 and (ii) a non-3GPP access network 410 that provides 5G connectivity to the particular network slice in this PLMN 420. The following steps specify how the UE 402 carries out this selection with emphasis on how the UE selects a non-3GPP access network 410 that provides 5G connectivity to a particular network slice in the selected PLMN 420.

It is assumed that the UE 402 can map the particular network slice included in the URSP rules, which is an S-NSSAI valid in the HPLMN, to a corresponding S-NSSAI, which is valid in the selected PLMN 420. In other words, when the UE 402 identifies, according to the URSP rules, that some data traffic should be sent over non-3GPP access and via a PDU Session using the network slice S-NSSAI-x (valid in HPLMN), the UE 402 would map this network slice to a corresponding S-NSSAI-y (valid in the selected PLMN) and then would attempt to select a non-3GPP access network 410 that provides 5G connectivity to S-NSSAI-y in the selected PLMN 420. The UE 402 can map S-NSSAIs valid in the HPLMN to corresponding S-NSSAIs valid in the selected PLMN 420 e.g., because it is provisioned with a Configured NSSAI for the selected PLMN 420 (as defined in TS 23.501). The Configured NSSAI is an existing information element in existing 3GPP specifications, but it is applied in this disclosure by a UE 402 for a different reason, i.e., for deciding which WLAN 410 to select.

In a first step (“step 1”), the UE 402 discovers the available WLANs 410 and, for each WLAN 410, it identifies: a) the PLMNs 420 and b) the Network Slice Non-3GPP Access Groups (NSNAGs) in each PLMN 420, to which 5G connectivity is supported.

The UE 402 identifies the PLMNs 420 and the network slice non-3GPP access groups (NSNAGs) in each PLMN 420, to which 5G connectivity is supported by a WLAN 410, by sending an ANQP request message to the WLAN 410 requesting “3GPP Cellular Network” information and receiving an ANQP response message containing “3GPP Cellular Network” information.

The “3GPP Cellular Network” information in the ANQP response contains one or more of the following PLMN lists, as defined in TS 24.302, Annex H: PLMN List; PLMN List with S2a connectivity; PLMN List with trusted 5G connectivity; PLMN List with trusted 5G connectivity-without-NAS.

The UE 402 considers only the PLMNs 420 included in the “PLMN List with trusted 5G connectivity” because the UE 402 has decided to register to a 5G PLMN 420 over trusted non-3GPP access (as assumed in step 0).

The “PLMN List with trusted 5G connectivity” is enhanced to contain, not only a list of PLMNs 420 to which 5G connectivity is supported by a WLAN 410 (as presented specified), but also one or more network slice non-3GPP access groups (NSNAGs) in each PLMN 420.

For example, the UE 402 discovers the following three WLANs 410. The WLAN 410 with SSID-x supports 5G connectivity to the NSNAG-A and NSNAG-B in PLMN-1 and to NSNAG-C in PLMN-2. At this point, the UE 402 does not know the network slices (S-NSSAIs) associated with each NSNAG, unless it has received ANDSP information, as further explained below.
SSID-x PLMN-1: NSNAG-A, NSNAG-B
   PLMN-2: NSNAG-C
SSID-y PLMN-1: NSNAG-D
SSID-Z PLMN-3: NSNAG-E

The WLANs 410 provide the supported NSNAG identities in each PLMN 420, instead of the supported network slices (S-NSSAIs) in each PLMN 420, for privacy reasons, i.e., to avoid disclosing the network slices supported by each PLMN 420, which can be sensitive information. The ANQP request/response messages are exchanged between the UE 402 and the WLAN 410 prior to association and, therefore, are transmitted without confidentiality protection.

In a second step (“Step 2”), the UE 402 creates a first list of available PLMNs 420, i.e., of PLMNs 420 to which 5G connectivity is supported by the available WLANs 410. In the above example, the first list of available PLMNs 420 contains: First list of available PLMNs 420=PLMN-1, PLMN-2, PLMN-3.

The first list of available PLMNs 420 indicates the 5G PLMNs 420 to which the UE 402 can connect via the available WLAN access networks 410.

In a third step (“Step 3”), from the first list of available PLMNs 420, the UE 402 selects a first PLMN 420, e.g., PLMN-1. This PLMN 420 selection is performed without considering slicing information (as defined in existing 3GPP specifications). The UE 402 selects the first PLMN 420 e.g., based on the Operator Controlled PLMN Selector list configured in the USIM module.

In a fourth step (“Step 4”), the UE 402 creates a second list of WLANs 410 that contains the WLANs 410 which support 5G connectivity to the selected (first) PLMN 420 and the NSNAGs supported by each WLAN 410. In the above example, the second list of WLANs 410 includes two WLANs 410 and three NSNAGs in the selected (first) PLMN 420:
SSID-x: NSNAG-A, NSNAG-B in PLMN-1
SSID-y: NSNAG-D in PLMN-1

In a fifth step (“Step 5”), the UE 402 applies the Access Network Discovery & Selection Policy (ANDSP) received from the selected (first) PLMN 420 to determine the network slices (S-NSSAIs) associated with the NSNAGs in the second list of WLANs 410. The ANDSP comprises network slice group information that contains a list of network slice groups applicable to non-3GPP access (e.g. NSNAGs) and one or more S-NSSAIs associated with each network slice group. Continuing with the above example, the UE 402 may determine that each WLAN 410 in the second list of WLANs 410 supports the following network slices:
SSID-x S-NSSAI-u, S-NSSAI-v in PLMN-1 (the ANDSP information maps NSNAG-A to S-NSSAI-u and NSNAG-B to S-NSSAI-v)
SSID-y S-NSSAI-v, S-NSSAI-w in PLMN-1 (the ANDSP information maps NSNAG-D to S-NSSAI-v and S-NSSAI-w).

According to existing 3GPP specifications, the ANDSP may contain two components: (a) Non-3GPP access node configuration information, that assists the UE 402 in selecting a non-3GPP access node (i.e., ePDG or N3IWF) in a PLMN 420 and discovering contact information (e.g., IP addresses or FQDNs) for non-3GPP access nodes in the HPLMN, and (b) WLAN Selection Policy (WLANSP) rules that provide preferences for the UE 402 to select a WLAN access network 410.

According to the present disclosure, the ANDSP is enhanced to contain also Non-3GPP Network Slice Group (NSNAG) information for a PLMN 420, which indicates the network slices (S-NSSAIs) associated with each NSNAG in this PLMN 420. In the above example, the NSNAG information in the ANDSP provided by PLMN-1 may contain:
NSNAG-A S-NSSAI-u
NSNAG-B S-NSSAI-v
NSNAG-C S-NSSAI-m, S-NSSAI-n
NSNAG-D S-NSSAI-v, S-NSSAI-w
NSNAG-E S-NSSAI-k

Using this NSNAG information, as well as the received “3GPP Cellular Network” information, the UE 402 determines that the WLAN 410 with SSID-x supports 5G connectivity to S-NSSAI-u and S-NSSAI-v in PLMN1, and the WLAN 410 with SSID-y supports 5G connectivity to S-NSSAI-v and S-NSSAI-w in PLMN1. The NSNAG information may be specified as an addition component in the ANDSP (independent from the existing two components) or may be embedded in an existing component.

The NSNAG information is provided to the UE 402 via a PCF in PLMN-1 using the existing UE policy configuration procedure, which applies the N1 confidentiality protection mechanisms. Thus, it cannot be inspected by unauthorized third parties.

The S-NSSAI values included in the NSNAG information may be S-NSSAIs in PLMN-1, which correspond to the UE's 402 subscribed S-NSSAIs in HPLMN. In other words, the NSNAG information provided to UE 402 by a PCF in PLMN-1 may be created by considering the UE's 402 subscribed S-NSSAIs. The PCF creates the NSNAG information by using one or more of: local configuration, information received from the OAM system, information received from the Unified Data Repository (UDR).

If the UE 402 has not received NSNAG information from the selected (first) PLMN 420, i.e., the UE 402 has not received ANDSP from the selected (first) PLMN 420 or the UE 402 has received ANDSP from the selected (first) PLMN 420, but it does not contain NSNAG information, then:
The UE 402 may be able to determine the S-NSSAIs associated with a NSNAG using other means. For example, the UE 402 may have received and stored the NSNAG information for the selected PLMN 420 during a prior registration procedure with this PLMN 420. If, for instance, the UE 402 is registered to the selected PLMN 420 via 3GPP access, the UE 402 may have received the NSNAG information within the Configured NSSAI or another information element included in the Registration Accept message or UE Configuration Update Command.

The immediately above paragraph specifies one example method for providing the NSNAG information to the UE 402. The NSNAG information may be provided to UE 402 either (i) as part of ANDSP, which is sent to UE 402 using the UE policy configuration procedure, or (ii) with an information element included in the Registration Accept message, such as the Configured NSSAI.

If the UE 402 is unable to determine the S-NSSAIs associated with a NSNAG, then the UE 402 selects a first WLAN 410 from the second list of WLANs 410 without considering slicing information, as defined in the next step.

It will be appreciated that although the selection method specified in this disclosure is applicable to “trusted” non-3GPP accesses, the concept of providing the UE 402 with NSNAG information and using this information to identify the S-NSSAIs associated with each NSNAG, is also applicable to “untrusted” non-3GPP accesses. In other words, the UE 402 can apply the NSNAG information to determine which S-NSSAIs can be supported by an N3IWF (i.e., the network function that supports untrusted non-3GPP access to 5G core).

In a sixth step (“Step 6”), the UE 402 selects a first WLAN 410 from the second list of WLANs 410 that supports 5G connectivity to a requested network slice in the first PLMN 420, wherein the requested network slice is an S-NSSAI associated with one or more NSNAGs in the second list of WLANs 410. In the above example, if the requested S-NSSAI=S-NSSAI-u, the UE 402 selects SSID-x. If the requested S-NSSAI=S-NSSAI-w, the UE 402 selects SSID-y. If the requested S-NSSAI=S-NSSAI-v, the UE 402 can select either SSID-x or SSID-y. This selection can be based on UE 402 implementation-specific criteria, or on the WLAN Selection Policy (WLANSP) rules that may have been provided to UE 402 by the selected (first) PLMN 420, which contain preferences for WLAN 410 selection.

As mentioned in step 0, the requested network slice may be determined by the UE 402 using the URSP rules in the UE 402. For example, when the UE 402 identifies, according to the URSP rules, that some data traffic should be sent over non-3GPP access and via a PDU Session using the network slice S-NSSAI-x (valid in HPLMN), the UE 402 would map this network slice to a corresponding S-NSSAI-y (valid in the selected PLMN). This corresponding S-NSSAI-y is the requested network slice, and the UE 402 would attempt to selects a non-3GPP access network 410 that provides 5G connectivity to S-NSSAI-y in the selected PLMN 420.

If the UE 402 is unable to determine the S-NSSAIs associated with a NSNAG (see end of step 5), then the UE 402 selects a first WLAN 410 from the second list of WLANs 410 without knowing which S-NSSAIs are supported by each WLAN 410 in the second list of WLANs 410. In the above example, where the second list of WLANs 410 contains SSID-x and SSID-y, the UE 402 may first select the SSID-x and attempt to register to the requested network slice in the first PLMN 420. If this fails, e.g., because the SSID-x does not support connectivity to the requested network slice, the UE 402 may select SSID-y and attempt again to register to the requested network slice in the first PLMN 420.

In a seventh step (“Step 7”), the UE 402 initiates a “5G registration via trusted non-3GPP access” procedure (currently defined in TS 23.502) to register to the requested network slice in the selected (first) PLMN 420 via the selected (first) WLAN 410.

All the above-described steps are summarized in Table 1 below.

TABLE 1
Step 0: The UE decides to register to S-NSSAI-u in a 5G PLMN over non-3GPP access.
This may be decided e.g., when the UE attempts to send data traffic which, according to the URSP rules in the UE,
should be sent over non-3GPP access and via a PDU Session using S-NSSAI-u.
Step 1: The UE uses ANQP to discover the PLMNs and the corresponding NSNAGs to which (trusted) 5G connectivity

| | |
|---|---|
| | is supported. The PLMN List-3 is enhanced to contain NSNAGs. |
| SSID-x | PLMN-1: NSNAG-A, NSNAG-B |
| | PLMN-2: NSNAG-C |
| SSID-y | PLMN-1: NSNAG-D |
| SSID-z | PLMN-3: NSNAG-E |

```
Step 2: The UE creates a first list of available PLMNs, i.e., of PLMNs to which 5G connectivity is supported by the
available WLANs. In the above example, the first list of available PLMNs contains:
      First list of available PLMNs = PLMN-1, PLMN-2, PLMN-3
Step 3: From the first list of available PLMNs, the UE selects a first PLMN, e.g., PLMN-1.
This PLMN selection is performed without considering slicing information (as presently defined). The UE selects the
first PLMN e.g., based on the Operator Controlled PLMN Selector list configured in the USIM module.
Step 4: The UE creates a second list of WLANs that contains the WLANs which support 5G connectivity to the selected
(first) PLMN and the NSNAGs supported by each WLAN. In the above example, the second list of WLANs includes
two WLANs and three NSNAGs in the selected (first) PLMN:
    SSID-x: NSNAG-A, NSNAG-B in PLMN-1
    SSID-y: NSNAG-D in PLMN-1
Step 5: The UE applies the Access Network Discovery & Selection Policy (ANDSP) received from the selected (first)
PLMN to determine the network slices (S-NSSAIs) associated with the NSNAGs in the second list of WLANs.
```

| | |
|---|---|
| SSID-x | S-NSSAI-u, S-NSSAI-v in PLMN-1 |
| SSID-y | S-NSSAI-v, S-NSSAI-w in PLMN-1 |

ANDSP is enhanced to contain “NSNAG information” which maps NSNAGs to S-NSSAIs, e.g.:

| | |
|---|---|
| NSNAG-A | S-NSSAI-u |
| NSNAG-B | S-NSSAI-v |
| NSNAG-C | S-NSSAI-m, S-NSSAI-n |
| NSNAG-D | S-NSSAI-v, S-NSSAI-w |
| NSNAG-E | S-NSSAI-k |

Step 6: The UE selects a first WLAN from the second list of WLANs that supports 5G connectivity to a requested
network slice in the first PLMN, wherein the requested network slice is an S-NSSAI associated with one or more
NSNAGs in the second list of WLANs.
Step 7: The UE initiates a “5G registration via trusted non-3GPP access” procedure (currently defined in TS 23.502) to
register to the requested network slice in the selected (first) PLMN via the selected (first) WLAN.

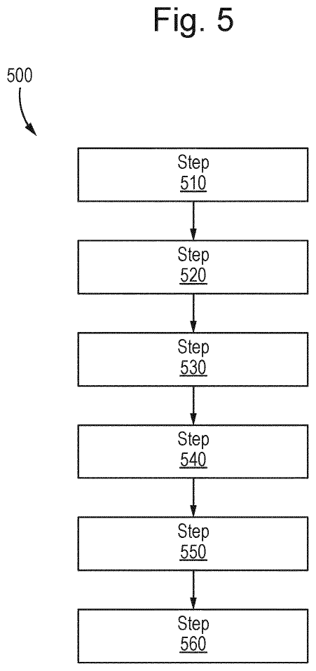

FIG. 5 illustrates a flowchart showing steps performed in a method 500 performable by a UE as described herein. The UE may be, for example, the remote unit 102 of FIG. 1 or the UE 402 of FIG. 4.

At step 510, the UE creates a first list of available public land mobile networks, PLMNs, connectable via available non-3GPP access networks using a first connectivity type.

At step 520, the UE selects from the first list of available PLMNs a first PLMN.

At step 530, the UE creates a second list of available non-3GPP access networks. The second list contains all available non-3GPP access networks that support connectivity using the first connectivity type to the first PLMN and one or more Network Slice Non-3GPP Access Groups, NSNAGs, supported by each of the available non-3GPP access networks.

At step 540, the UE determines network slices associated with the NSNAGs in the second list.

At 550, the UE selects a first non-3GPP access network from the second list of available non-3GPP access networks. The first non-3GPP access network supports the first type of connectivity to a requested network slice in the first PLMN. The requested network slice is a network slice associated with one or more NSNAGs in the second list.

At step 560 the UE begins a registration procedure with the first PLMN, the registration procedure requesting support of the requested network slice in the first PLMN.

The creation of the first list may comprise discovering all available non-3GPP access networks, for each available non-3GPP access network identifying one or more PLMNs to which the first connectivity type is supported, and including all the PLMNs to which the first connectivity type is supported in the first list.

The method may further comprise for each available non-3GPP access network, identifying one or more NSNAGs in each PLMN.

The determination of the network slices associated with each NSNAG may be performed using NSNAG information received either: within an Access Network Discovery and Selection Policy, ANDSP, of the first PLMN or within a Registration Accept message received from the first PLMN.

The ANDSP of the first PLMN may be provided with an N1 signaling procedure.

The ANDSP of the first PLMN may be provided using a user equipment, UE, policy management procedure.

The non-3GPP access networks may comprise Wireless Access Networks, WLANs.

The first connectivity type may be 5G connectivity.

The determination of the network slices may comprise determination of Network Slice Selection Assistance Information, S-NSSAI.

The NSNAG information may contain one or more NSNAG identifiers and a list of associated S-NSSAIs for each NSNAG identifier.

It will be appreciated that the UEs 102, 200 described above may communicate with and/or connect to the above-described WLANs 410 and/or PLMNs 420 via one or more of the above-described network units/nodes 104, 300.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
creating a first list of available public land mobile networks, (PLMNs) connectable via available non-3rd generation partnership project (non-3GPP) access networks using a first connectivity type;
selecting from the first list of available PLMNs a first PLMN;
creating a second list of available non-3GPP access networks, the second list containing all available non-3GPP access networks that support connectivity using the first connectivity type to the first PLMN and one or more network slice non-3GPP access groups (NSNAGs) supported by each of the available non-3GPP access networks;
determining network slices associated with the NSNAGs in the second list;
selecting a first non-3GPP access network from the second list of available non-3GPP access networks, wherein the first non-3GPP access network supports the first type of connectivity to a requested network slice in the first PLMN, and wherein the requested network slice is a network slice associated with one or more NSNAGs in the second list; and
beginning a registration procedure with the first PLMN, wherein the registration procedure requests support of the requested network slice in the first PLMN.

2. The method of claim 1, wherein the creating the first list comprises:
discovering all available non-3GPP access networks;
for each available non-3GPP access network, identifying one or more PLMNs to which the first connectivity type is supported; and
including all the PLMNs to which the first connectivity type is supported in the first list.

3. The method of claim 2, further comprising:
for each available non-3GPP access network, identifying one or more NSNAGs in each PLMN.

4. The method of claim 1, wherein the determining the network slices associated with the NSNAGs in the second list comprises using NSNAG information received either:
within an access network discovery and selection policy (ANDSP), of the first PLMN; or
within a registration accept message received from the first PLMN.

5. The method of claim 4, wherein the ANDSP of the first PLMN is provided using a UE policy management procedure.

6. The method of claim 1, wherein the non-3GPP access networks comprise wireless access networks (WLANs).

7. The method of claim 1, wherein the first connectivity type is 5G connectivity.

8. The method of claim 1, wherein the determining the network slices comprises determination of network slice selection assistance information (S-NSSAI).

9. The method of claim 4, wherein the NSNAG information contains one or more NSNAG identifiers and a list of associated network slice selection assistance information (S-NSSAIs) for each NSNAG identifier.

10. (canceled)

11. A user equipment (UE) for wireless communication, comprising:
at least one memory; and
at least one processor coupled with the at least one memory and configured to cause the UE to:
create a first list of available public land mobile networks (PLMNs) connectable via available non-3rd generation partnership project (non-3GPP) access networks using a first connectivity type;
select from the first list of available PLMNs a first PLMN;
create a second list of available non-3GPP access networks, the second list containing all available non-3GPP access networks that support connectivity using the first connectivity type to the first PLMN and one or more network slice non-3GPP access groups (NSNAGs) supported by each of the available non-3GPP access networks;
determine network slices associated with the NSNAGs in the second list;
select a first non-3GPP access network from the second list of available non-3GPP access networks, wherein the first non-3GPP access network supports the first type of connectivity to a requested network slice in the first PLMN, and wherein the requested network slice is a network slice associated with one or more NSNAGs in the second list; and
begin a registration procedure with the first PLMN, wherein the registration procedure requests support of the requested network slice in the first PLMN.

12. The UE of claim 11, wherein, to create the first list, the at least one processor is further configured to cause the UE to:
discover all available non-3GPP access networks;
for each available non-3GPP access network, identify one or more PLMNs to which the first connectivity type is supported; and
include all the PLMNs to which the first connectivity type is supported in the first list.

13. The UE of claim 12, wherein the processor is further configured to cause the UE to:
for each available non-3GPP access network, identify one or more NSNAGs in each PLMN.

14. The UE of claim 11, wherein, to determine the network slices associated with each NSNAG, the at least one processor is further configured to use NSNAG information received either:
within an access network discovery and selection policy (ANDSP), of the first PLMN; or
within a registration accept message received from the first PLMN.

15. The UE of claim 14, wherein the ANDSP of the first PLMN is provided using a UE policy management procedure.

16. The UE of claim 11, wherein the non-3GPP access networks comprise wireless access networks (WLANs).

17. The UE of claim 11, wherein the first connectivity type is 5G connectivity.

18. The UE of claim 11, wherein, to determine the network slices, the at least one processor is further configured to cause the UE to determine network slice selection assistance information (S-NSSAI).

19. The UE of claim 14, wherein the NSNAG information contains one or more NSNAG identifiers and a list of associated network slice selection assistance information (S-NSSAIs) for each NSNAG identifier.

20. (canceled)

21. (canceled)

22. Processor for wireless communication, comprising:
at least one controller coupled with at least one memory and configured to cause the processor to:
create a first list of available public land mobile networks (PLMNs) connectable via available non-3rd generation partnership project (non-3GPP) access networks using a first connectivity type;
select from the first list of available PLMNs a first PLMN;
create a second list of available non-3GPP access networks, the second list containing all available non-3GPP access networks that support connectivity using the first connectivity type to the first PLMN and one or more network slice non-3GPP access groups (NSNAGs) supported by each of the available non-3GPP access networks;
determine network slices associated with the NSNAGs in the second list;
select a first non-3GPP access network from the second list of available non-3GPP access networks, wherein the first non-3GPP access network supports the first type of connectivity to a requested network slice in the first PLMN, and wherein the requested network slice is a network slice associated with one or more NSNAGs in the second list; and
begin a registration procedure with the first PLMN, wherein the registration procedure requests support of the requested network slice in the first PLMN.

23. A base station for wireless communication, comprising:
at least one memory; and
at least one processor coupled with the at least one memory and configured to cause the base station to:
transmit an access network discovery and selection policy (ANDSP) to a user equipment (UE), wherein the ANDSP comprises network slice group information that contains a list of network slice groups applicable to non-3rd generation partnership project (non-3GPP) access and one or more network slice selection assistance information (S-NSSAIs) associated with each network slice group, for the UE to apply the network slice group information for selecting a non-3GPP access network that supports a first type of connectivity to a requested network slice in a public land mobile network (PLMN).
